(19) United States
(12) Patent Application Publication
(10) Pub. No.: US 2013/0250443 A1
(43) Pub. Date: Sep. 26, 2013

(54) PORTABLE MAGNIFYING DEVICE AND USES THEREOF

(71) Applicant: THE PROCTER & GAMBLE COMPANY, Cincinnati, OH (US)

(72) Inventor: Qingli KONG, Beijing (CN)

(73) Assignee: THE PROCTER & GAMBLE COMPANY, Cincinnati, OH (US)

(21) Appl. No.: 13/787,865

(22) Filed: Mar. 7, 2013

(30) Foreign Application Priority Data
Mar. 21, 2012 (CN) PCT/CN2012/072692

(51) Int. Cl. G02B 25/00; G02B 25/02

(52) U.S. Cl. CPC G02B 25/008; G02B 25/02
USPC 359/802; 359/804

(57) ABSTRACT

A portable magnifying device is provided comprising a housing and a viewing plate mounted inside the housing, the housing comprises at least one magnifying lens disposed within a top surface of the housing, and the viewing plate is configured to support a substrate that can be viewed through the magnifying lens. The portable magnifying device can be used to allow consumers to visually assess the effectiveness of a treatment of a product on a substrate at the micro level.

### FIELD OF THE INVENTION

This invention is directed to a portable magnifying device, and methods for using the portable magnifying device to allow consumers to visually assess effectiveness of a treatment of a product on a substrate at the micro level.

### BACKGROUND OF THE INVENTION

Demonstrations, whether live or standalone, are effective and inexpensive means to promote and market new products or new benefits of existing products to the consumers. Live demonstrations can take the form of, for example, in-store presentations or door-to-door traveling demos. In contrast, standalone demonstrations mainly involve placement of the demo articles at various sites, for example, on store shelves near the products or some other high traffic areas in the store. Either way, it is useful if the articles used in the demonstrations can be portable to various sites and require minimal display space. Unfortunately, both properties can be difficult to achieve when the demonstrations involve magnification.

The goal of any demonstration is to convince consumers to buy the product by showing its superior performance over the competition. Typically, in the household and fabric care industries, this is achieved by treating a substrate (e.g., clothing, countertop, dishes) with the product (e.g., laundry detergent, surface cleaners, dish detergents), and allowing the consumers to view the treated substrate in comparison to a control to assess the effectiveness of the treatment. Additionally, two or more comparative products can be tested side-by-side to show the effectiveness of the treatment using the product against its competitors. For some products, however, the consumers cannot readily assess their effectiveness because the differences in visual appearance of the treated substrates are not readily visible to the naked eye or the differences are not readably discernible. Hence, the consumers require magnification of the treated substrates to effectively view the differences.

The two most common ways to achieve this is to provide the consumers with a microscope or blown-up images of the treated substrates. While a microscope is effective in magnifying the treated substrate, it is a heavy and sensitive piece of equipment that is difficult to transport and setup, which makes it not ideal for use in demonstrations. Alternatively, blown-up images have been routinely employed in demos. However, there are a number of challenges with this approach. The blown-up images are bulky and require a lot of room for display. Therefore, they can only be used in large stores that have enough space and cannot be readily displayed on store shelves. Moreover, the blown-up images are difficult to transport and are prone to being damaged during transport. Lastly, consumers regard the use of blown-up images in demonstrations with skepticism because of the perception that they might have been doctored or visually enhanced to unfairly favor the demonstrator's product over the competition. Accordingly, the need exists for a portable magnifying device, which can be conveniently and easily transported to various sites to be used in demonstrations to consumers. The need also exists for a method for demonstrating to the consumers a portable viewing of the effectiveness of the treatment of products on substrates at the micro level.

### SUMMARY OF THE INVENTION

In a first aspect, the present invention is directed to a portable magnifying device. Specifically, the present invention is directed to a portable magnifying device for providing to a consumer a portable viewing of the effectiveness of a treatment of a product on a substrate comprising a housing and a viewing plate mounted inside the housing, the housing comprises at least one magnifying lens, preferably comprises three magnifying lenses, disposed within a top surface of the housing, and the viewing plate is configured to support the substrate such that it can be viewed through the magnifying lens by the consumer.

In another aspect, the invention provides for a method for providing to a consumer a portable viewing of the effectiveness of a treatment of a product on a substrate, the method comprising the steps of:
(a) providing a first substrate treated with a first product;
(b) placing the first treated substrate into a portable magnifying device, the portable magnifying device comprises a housing and a viewing plate mounted inside the housing, the housing comprises at least one magnifying lens, preferably comprises three magnifying lenses, disposed within a top surface of the housing, and whereby the first treated substrate is supported by the viewing plate such that it can be viewed through the magnifying lens;
(c) viewing the first treated substrate through the magnifying lens;
(d) allowing the consumer to compare the first treated substrate with a control substrate not treated with the product according to steps (b) and (c); and
(e) allowing the consumer to visually assess effectiveness of the treatment as indicated by a different appearance of the first treated substrate versus the control substrate.

In another aspect, the invention provides for a kit of parts (whether assembled or not) for providing to a consumer portable viewing of the effectiveness of a treatment of a product on a substrate, which comprises the portable magnifying device, as set forth above.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1A is a top front view of an embodiment of the portable magnifying device according to the present invention.

FIG. 1B is a top back view of an embodiment of the portable magnifying device according to the present invention.

FIG. 1C is a top view of an embodiment of the portable magnifying device according to the present invention.

FIG. 1D is a top back view of an embodiment of the portable magnifying device where the viewing plate is partially outside of the housing.

FIG. 2A is a schematic of another embodiment of the portable magnifying device according to the present invention.

FIG. 2B is a schematic of another embodiment of the portable magnifying device according to the present invention.

FIG. 3 is a 10× magnified image of treated substrates according to an embodiment of the method of the present invention.

FIG. 4 is a 10× magnified image of treated substrates according to an embodiment of the method of the present invention.

FIG. 5 is a top view of another embodiment of the portable magnifying device according to the present invention.

FIG. 6 is a schematic of an embodiment of the shelving system of the portable magnifying device according to the present invention.

### DETAILED DESCRIPTION OF THE INVENTION

It is to be understood that the scope of the claims is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a”, “an”, and “the” include the plural.

As used herein, any of the terms “comprising”, “having”, “containing”, and “including” means that other steps, ingredients, elements, etc. which do not adversely affect the end result can be added. Each of these terms encompasses the terms “consisting of” and “consisting essentially of”. Unless otherwise specifically stated, the elements and/or equipments herein are believed to be widely available from multiple suppliers and sources around the world.

As used herein, the term “about” when placed before a numerical value “X” refers to an interval extending from X minus 10% of X to X plus 10% of X, preferably to an interval extending from X minus 5% of X to X plus 5% of X, and even more preferably to an interval extending from X minus 2% of X to X plus 2% of X.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “1.2 cm” is intended to mean “about 1.2 cm”.

As used herein, the term “consumers” is meant to include the customers who purchase the product as well as the store owners who decide whether to stock their shelves with the product. There is clearly value to the demonstrator to have both parties view the demonstration using the portable magnifying device.

The present invention is directed to a portable magnifying device that provides to a consumer a portable viewing of the effectiveness of a treatment of a product on a substrate. Specifically, the portable magnifying device has a housing and a viewing plate mounted inside the housing. The housing has at least one magnifying lens, preferably three magnifying lenses, disposed within a top surface of the housing. The viewing plate is configured to support the substrate such that the consumers can view it through the magnifying lens.

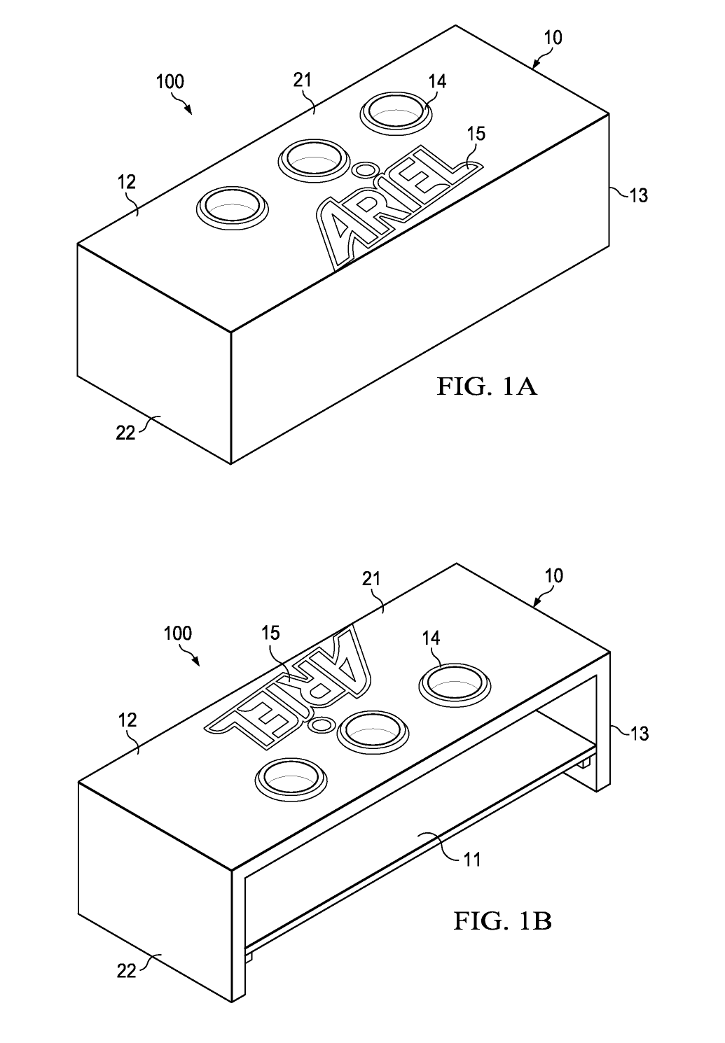

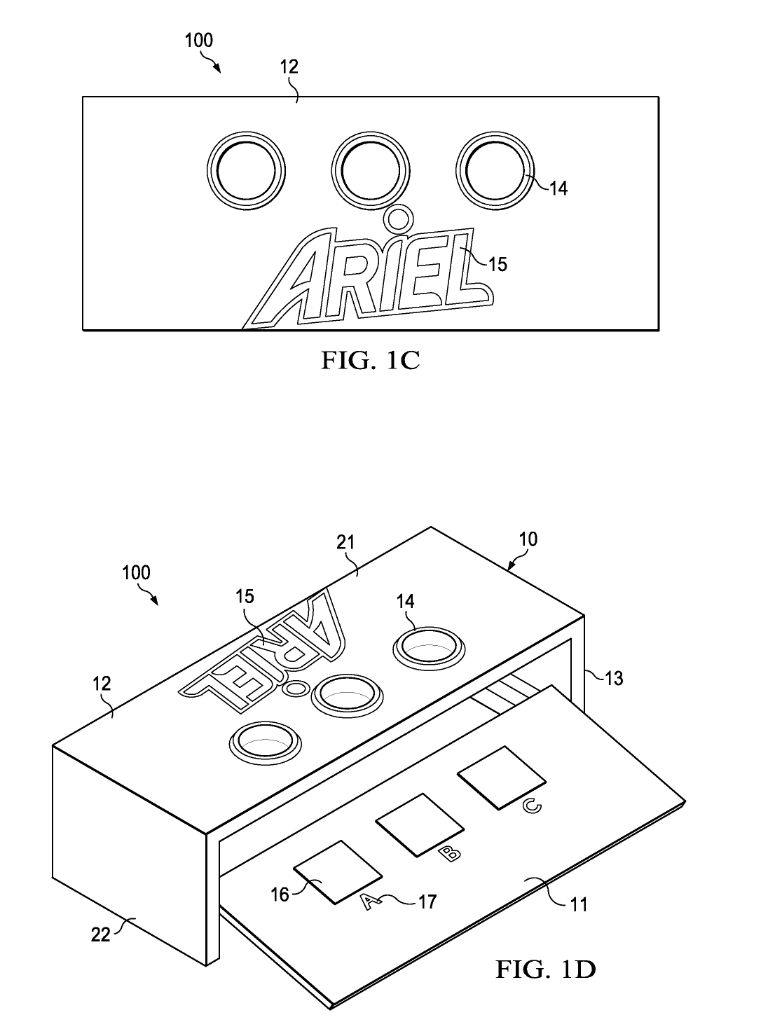

The portable magnifying device can be of any dimensions so long as it is small enough to be easily transported to different sites and conveniently fits into the available display space. For example, referring to the embodiment illustrated in FIGS. 1A-1D, the length×width×height dimensions of the portable magnifying device, 100, can be 30 cm×10 cm×6 cm. Other embodiments are contemplated, such that the dimensions can be as small as, for non-limiting example, 10 cm×5 cm×5 cm. The smaller size is advantageous for traveling, particularly air travel, where luggage space is limited and the cost for additional cargo space is expensive. Furthermore, the portable magnifying device, 100, can operate as separate detachable units, in which each unit would comprise one magnifying lens. More than one separate unit can then be assembled together depending on the particular needs of the demonstrator.

Referring to FIG. 1A, an embodiment of the present invention relates to a portable magnifying device, 100, having a box-like appearance. Other appearances can be used herein, such as a product-like appearance, a case-like appearance, a microscope-like appearance or the like. The portable magnifying device, 100, can be made from any materials which can be molded or shaped, while still being durable enough to hold up to being transported around without breaking down. Non-limiting examples include plastic, steel, wood and combinations thereof. Preferably, the materials are hard plastics such as polycarbonate, polyethylene (PE), polypropylene (PP), polyvinylchloride (PVC) or the like. Further, the portable magnifying device, 100, can be made of stain-proof materials, which makes the portable magnifying device easy to clean.

As can be seen from FIG. 1B, the portable magnifying device, 100, includes a housing, 10, and a viewing plate, 11. The external surfaces of the housing, 10, has an optional mark, 15, such as a product logo, linking the portable magnifying device, 100, to the product to be demonstrated. Other marks, such as a pattern, a character, a logo, a word, a letter, a claim, a slogan, a picture, a photo, or a combination thereof, which can be used to make the portable magnifying device, 100, appear more appealing to the consumers and/or communicate to the consumers some related information, such as new benefits, as shown in FIG. 1B.

The housing, 10, has a top cover, 12, and a main body, 13. The top cover, 12, of the portable magnifying device, 100, includes at least one magnifying lens, 14, disposed within it, and through which the consumer can view the substrates. With this arrangement, the different substrates (e.g., control, treated with the product, and treated with the competitor's product) have to be switched out in order to perform the comparison. Alternatively, there can be three magnifying lenses, 14, which is advantageous since this allows the consumer to compare the control, the product and one competitor's product at the same time. Alternatively, the top cover, 12, may include two, four, five, six or as many magnifying lenses, 14, as needed for viewing, but only if it allows for sufficient spacing between each lens to view the substrates.

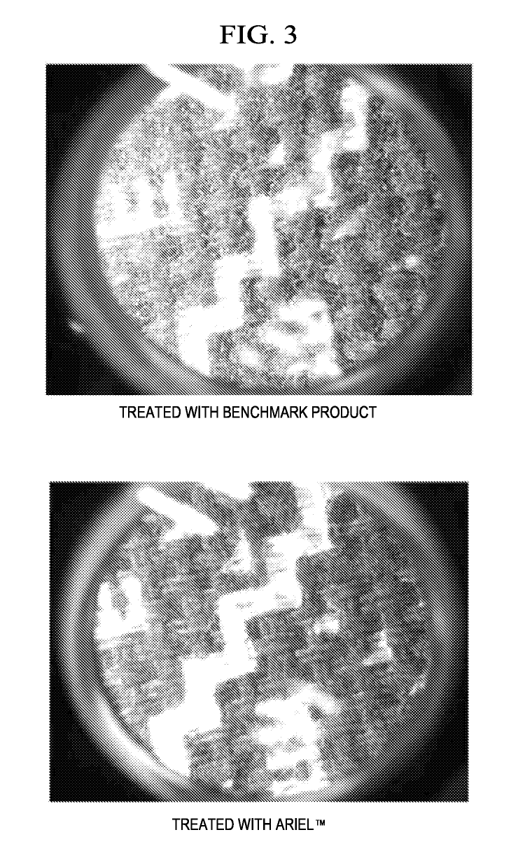

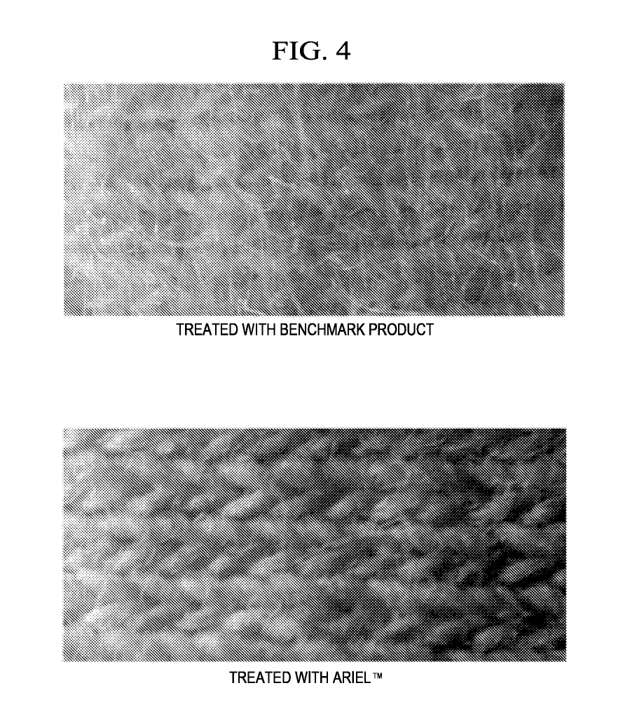

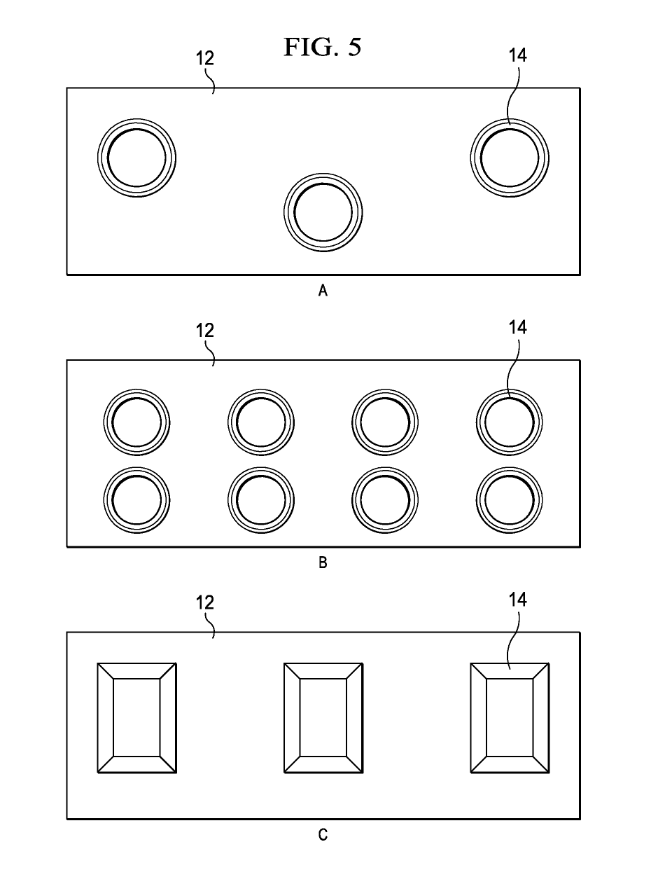

According to FIG. 1C, the magnifying lenses, 14, can be evenly spaced in a straight line in the center of the top cover, 12. Alternatively, it is possible that the magnifying lenses, 14, can be in any other arrangements so long as it is convenient for the consumer to view the substrates. Exemplary illustrations of other embodiments are provided in FIG. 5. The magnifying lenses, 14, can have magnification strength of from about 2× to about 100×, preferably from about 5× to about 50×, and more preferably from about 5× to about 10×. The magnification strength selected will depend upon various factors such as the surface of the substrate being evaluated, the depth of field required, the distance between the magnifying lenses and the substrate, and the like. With reference to FIGS. 3 and 4, exemplary magnified images of the substrates are provided. According to FIG. 3, the inventors have found that when the substrate is a fabric, the magnification strength of 10× can be used to effectively view residue deposition on the fabric while still maintaining the portability of the device. Referring to FIG. 4, the magnification strength of 10× can also be employed to observe the fabric integrity (i.e., fiber smoothness, pills and fuzz), although, higher magnification can be used to provide a better view of the fiber breakage.

In an embodiment, all the magnifying lenses can have the same magnification strength. Alternatively, the magnifying lenses, 14, can have different magnification strengths. For example, there could be two sets of magnifying lenses, 14, whereby one set has weaker magnification strength than the other. This arrangement can be useful to demonstrate the effectiveness of different products at varying degrees of magnification.

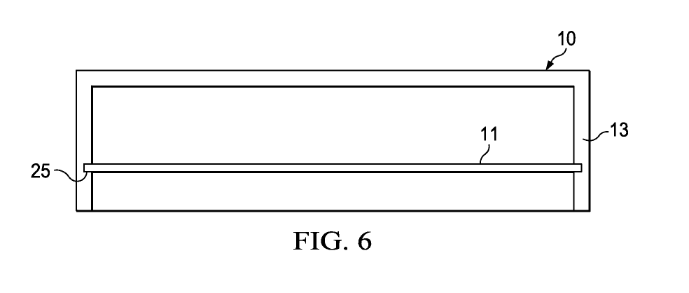

As shown in FIG. 1D, the viewing plate, 11, may be mounted inside the housing, 10. Preferably, the viewing plate, 11, can be releasably mounted so that the demonstrator can easily remove the viewing plate, 11, from the housing, 10, to conveniently attach or replace the substrates, 16. As depicted in FIG. 6, the viewing plate, 11, may rest on a shelving system that may take the form of pre-cut slots, 25, in the inner wall of the main body, 13, into which the viewing plate, 11, is releasably secured. Any other shelving system is also useful herein for supporting the viewing plate, 11, such as a railing including a plurality of mounting support, support pins that can be releasably secured to the inner wall of the housing, 10, or the like.

The shelving system can exist at a plurality of vertical levels, preferably at least two levels, to allow the demonstrator to change the distance between the magnifying lenses, 14, and the substrates, 16, as needed based on the magnification required for the type of substrates, 16, being evaluated. The distance between the magnifying lenses and the substrate is one of the factors that will impact the magnification of the substrate. Typically, the demonstrator can move the substrate closer to the magnifying lens to increase the magnification. For example, referring to FIGS. 3 and 4, the inventors determined that the preferred distance between the substrate and the bottom of the magnifying lens with a magnification strength of 10× is about 1.5 cm. Alternatively, other distances can also be operable, so long as they can still provide a clear view of the magnified substrates. Accordingly, the viewing plate, 11, can be positioned at a distance of from about 1.0 cm to 1.8 cm, preferably from about 1.2 cm to about 1.6 cm, and more preferably from about 1.5 cm, from the magnifying lenses, 14.

Referring now to FIG. 1D, in the particular embodiment shown of the present invention, the portable magnifying device, 100, is described herein for the visual assessment of fabric treated with a laundry product. However, it will be appreciated by those of ordinary skill in the art that the present invention has use in a wide variety of applications and is therefore not limited to the analysis of fabric or the properties specific to this substrate. Rather, the portable magnifying device, 100, is readily adaptable to analyze a wide variety of substrates and to assess different properties of those substrates as will be readily appreciated by those of ordinary skill in the art.

Accordingly, the substrate, 16, may be selected from any desired material depending upon the type of demonstration. Non-limiting examples of suitable substrates for use with the portable magnifying device, 100, are selected from fabric (i.e., synthetic, non-synthetic), human skin (i.e., real, synthetic), human hair (i.e., real, synthetic), human oral cavity (i.e., teeth, tongue, buccal surfaces), household hard surfaces, dish surfaces or the like. Preferably, the substrate, 16, is fabric selected from cotton, wool, silk, lycra, spandex, hemp, bamboo, rayon, polyester, linen, or mixtures thereof. Even more preferably, the fabric is cotton comprising of thick fibers formed in a network with spaces among the fibers capable of capturing insoluble particles, such as, detergent residues. The fabric can be white or colored, preferably colors such as, green, red, orange, blue, black or mixtures thereof. Preference is for the darker shades, which tend to contrast more with the lighter colored detergent residues and easier to detect by the consumers.

According to FIG. 1D, the substrate, 16, can be cut into about 2″×2″ squares. However, the substrate, 16, may, of course, have any desired size and shape, such as, for non-limiting example, the substrates can be 1″×2″ and oval in shape or 2″×4″ and rectangular in shape. The size in part will, of necessity, be a function of the dimensions of the viewing plate, which is constrained by the overall dimension of the portable magnifying device and the type of demonstration being used.

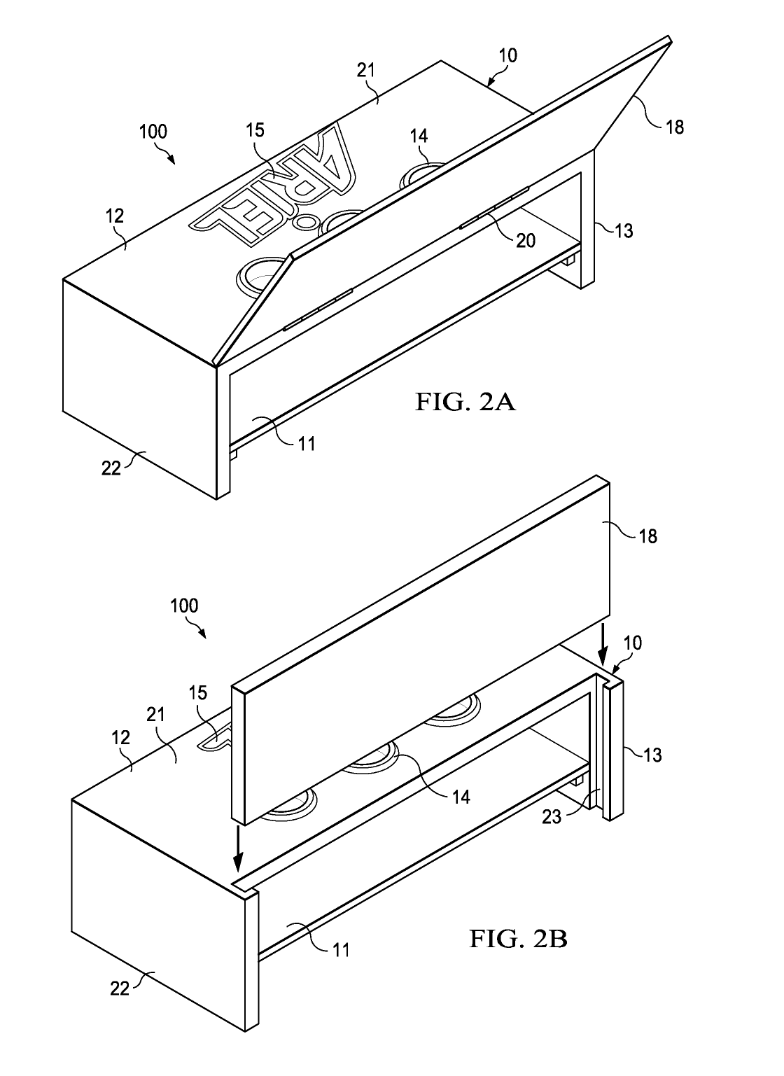

The substrates, 16, can be held in place on the viewing plate, 11, by a locking device, such as, for non-limiting example hook and loop fasteners (e.g., Velcro™), slide fasteners, snap-in locking device, or the like. Alternatively, the substrates, 16, can be affixed to the viewing plate, 11, by an adhesive or glue, screws, fasteners or the like. Referring to FIG. 2A, identifier information, 17, can be provided below, above, or next to the substrates, 16, on the viewing plate, 11. The identifier information, 17, can be printed, hand written, card insert or the like. Alternatively, the identifier information, 17, can be provided directly on the substrates, 16.

In an embodiment herein, the portable magnifying device, 100, of FIGS. 2A and 2B, further includes a cover, 18, on the back of the housing, 10, to block off exterior light from entering therein, at least one light source, 19, installed inside the housing, 10, to provide controlled illumination in the interior, and a battery, 24, to power the light source, 19. In this case, the demonstrator can control the illumination to ensure that suitable lighting is provided every time the portable magnifying device, 100, is used. For example, in the absence of a cover, 18, it would be difficult for the consumers to view the substrates at an outdoor demonstration on a bright sunny day due to too much light or at an in-store display in a dimly lit part of the store on account of too little light. Furthermore, the demonstrator can set the illumination to pre-established parameters (e.g., intensity, direction), which have been optimized for that particular demonstration. For example, in the case where the demonstrator wants to show that his laundry detergent is free of chemicals (e.g., hueing dyes), he can switch to a UV light source (i.e., black light) and if present, the hueing dyes will glow bluish-white.

Referring to FIG. 2A, the cover, 18, can be flexible and affixed to the housing, 10, by one or more hinges, 20, which permits the cover, 18, to swing back with respect to the housing, 10, and allow access to the interior. The hinges, 20, can be affixed to the top, 21, or the side, 22, of the housing, 10. Alternatively, referring now to FIG. 2B, the cover, 18, can rest on tracks, 23, affixed, either vertically or horizontally, to the backside of the housing, 10. When in use or during transport and storage, the cover, 18, is in the closed position to block out exterior light, and can be slid back to the open position when access to the interior is desired. The light source 19, can be a tungsten incandescent light bulb, a quartz halogen lamp, a UV lamp, a mercury vapor lamp, a light-emitting diode (LED) and the like, which provides a monochromatic, preferably white, or colored light suitable to view the substrates, 16. Preferably, the light source, 19, is an LED which has a longer life span and is more energy efficient than other light bulbs.

If present, the battery, 24, is disposed within the housing, 10, and configured to provide power to the light source, 19, as necessary, so that the device, 100, can be fully portable and operable at any location without requiring an external power source. The battery, 24, may be a fixed charged battery that needs to be replaced from time-to-time or it can be rechargeable, such as, for example alkaline battery, NiCad battery Lithium Ion battery, or the like. The rechargeable battery can be charged through a connector operatively coupled to a wall outlet.

Furthermore, in an embodiment (not shown), the portable magnifying device, 100, can have a handle, preferably two handles, on opposite ends of the main body, 13, to aid in its carriage or transport. The handles can be attached to the main body, 13, by adhesives, screws, fasteners or the like. The handles can be rigid or flexible. However, it will be appreciated by those of ordinary skill in the art that the handles can be attached to any other locations of the main body, 13 or the top cover, 12, so long as it allows the user to easily hold or carry the portable magnifying device, 100.

In another aspect, the present invention is directed to a method for providing to consumers a portable viewing of the effectiveness of a treatment of a product on a substrate. The method, according to the invention, comprises the provision of a first substrate that has been treated with a first product. The selection of the substrate material, as previously described, will depend on the type of product being demonstrated, such as, for example, laundry products, beauty products, oral care products, cleaning products (e.g., household hard surface, dish surfaces) or the like. Preferably, the product is a laundry product such as, for example, a detergent, fabric softener, bleach, laundry additive or mixtures thereof. Therefore, for example, when the product is a detergent, the substrate is a fabric, preferably cotton.

The method further comprises the steps of placing the first substrate onto a viewing plate in the portable magnifying device, as described herein, and viewing the first substrate through the magnifying lens. A control substrate, which has not been treated with the first product, is also viewed through the magnifying lens. The method further comprises the steps of allowing the consumers to compare the first treated substrate with the control substrate and visually assessing the effectiveness of the treatment with the first product. The effectiveness of the treatment may be assessed qualitatively by comparison of the appearance of the surfaces of the substrates.

For example, where the product is laundry products, the surface properties of the fabric (i.e., substrate) can be inspected for surface appearance, surface integrity (e.g., fiber breakages, pills, fuzz), amount of residue deposition, color hue (e.g., color changes), color intensity (e.g., fading) or the like. For example, where the product is a beauty product the surface properties of the human skin can be inspected for color hue (e.g., tanning, whitening), color intensity, wrinkles, tone, texture, discolorations, fine lines or the like. Alternatively, where the beauty products are intended for use on human hair, the inspected properties can be selected from surface appearance (e.g., smoothness, shine), surface integrity (e.g., cuticular breakdown, split ends), amount of residue deposition, color hue (e.g., color changes), color intensity (e.g., fading) or the like. For example, where the product is an oral care product, the surface properties of the human oral cavity can be inspected for tartar/calculus, plaque, cavity, color hue (i.e., whiteness), stains or the like. For example, where the product is a cleaning product the surface properties of the household hard surfaces or dishes can be inspected for surface appearance (e.g., shine), stains, amount of residue deposition or the like.

The method may also comprise the steps of providing a second substrate that has been treated with a second product, placing the second substrate on the viewing plate in the magnifying device, and viewing it through the magnifying lens. The method further comprises the steps of allowing the consumers to compare the first treated substrate with the second treated substrate and visually assessing the effectiveness of the treatments based on a difference in appearance of the first treated substrate versus the second treated substrate.

The present invention also provides kits that contain the portable magnifying device of the invention. The kit also includes instructions for assembly and use of the portable magnifying device for providing to the consumers portable viewing of the effectiveness of a treatment of a product on a substrate.

### EXAMPLE

Materials
Fabric: Thick woven cotton cut into 2″×2″ squares
Portable magnifying device: as described herein.
First laundry product: Ariel™
Second laundry product: benchmark product

Protocol

Depending on the benefit being communicated, some of the steps herein may be omitted or varied as required. In this example, the demonstration is being utilized to show the superior performance of Ariel™ laundry detergent versus a benchmark product for color care benefit based on viewing and comparison of the residue deposition and surface integrity of the treated fabrics.

Three fabric squares are provided. The first square is washed in a small bowl containing about 200 mL of water and about 10 g of Ariel™ for about 30 seconds without any scrubbing motion. The first square is then rinsed in clean water and wringed by hands to remove water and dried at ambient temperature. The first square is then secured on the viewing plate and the identifier information is added below it. Repeat the above steps for the second square, except a benchmark product is used instead of Ariel™. The third fabric square is left untreated and is secured to the viewing plate with the appropriate identifier information. The viewing plate is placed inside the portable magnifying device. The cover on the back of the housing is closed, and the light source is turned on. Consumers can now view the different substrates through the magnifying lenses. The effectiveness of the treatments is assessed according to the consumer's visual inspection of the surface properties of the fabric squares and comparing them to each other.

Assessment and Comparison of First Treated Substrate Versus Second Treated Substrate

As shown in FIG. 3, there is a considerable amount of white residue deposition on the fabric treated with benchmark product, whereas there is no residue on the fabric treated with Ariel™. Referring now to FIG. 4, there is obvious fiber breakage on the fabric treated with benchmark product in comparison to the Ariel™ treated fabric where the fibers are smooth. These differences are too small to have been discernible to the naked eye. This demonstrates that this method according to the present invention is effective for visually assessing and comparing the efficacy of different treatments of products on substrates at the micro level.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for providing to a consumer a portable viewing of the effectiveness of a treatment of a product on a substrate, the method comprising the steps of:
(a) providing a first substrate treated with a first product;
(b) placing the first treated substrate into a portable magnifying device, the portable magnifying device comprises a housing and a viewing plate mounted inside the housing, the housing comprises at least one magnifying lens, preferably comprises three magnifying lenses, disposed within a top surface of the housing, and whereby the first treated substrate is supported by the viewing plate such that it can be viewed through the magnifying lens;
(c) viewing the first treated substrate through the magnifying lens;
(d) allowing the consumer to compare the first treated substrate with a control substrate not treated with the product according to steps (b) and (c); and
(e) allowing the consumer to visually assess effectiveness of the treatment as indicated by a different appearance of the first treated substrate versus the control substrate.

2. The method according to claim 1, comprising the additional steps of:
(f) providing a second substrate treated with a second product;
(g) placing the second treated substrate into the portable magnifying device, whereby the second treated substrate is supported by the viewing plate such that it can be viewed through the magnifying lens;
(h) viewing the second substrate through the magnifying lens;
(i) allowing the consumer to compare the first treated substrate with the second treated substrate; and
(j) allowing the consumer to visually assess effectiveness of the treatments as indicated by a different appearance of the first treated substrate versus the second substrate.

3. The method according to claim 1 or 2, wherein the first and second substrates are independently selected from fabric, human skin, human hair, human oral cavity (i.e., teeth, gums, tongue and buccal surfaces), household hard surfaces, or dish surfaces; preferably wherein the fabric is selected from cotton, wool, silk, nylon, lycra, spandex, hemp, bamboo, rayon, polyester, linen, or mixtures thereof; and more preferably cotton.

4. The method according to claim 3, wherein the cotton comprises of thick fibers formed in a network with spaces dispersed therein capable of capturing insoluble particles and selected from the colors green, red, orange, blue, black, or mixtures thereof.

5. The method according to any of the preceding claims, wherein the product is selected from laundry products, beauty products, oral care products, or cleaning products; preferably wherein the laundry products are detergent, fabric softener, bleach, laundry additives, or mixtures thereof.

6. The method according to claim 5, wherein the effectiveness of the treatment is determined by visually assessing the properties of the fabric including: surface appearance, surface integrity, amount of residue deposition, color hues, or color intensity.

7. The method according to claim 1, wherein the magnifying device further comprises:
a cover configured to block off exterior light from entering the housing; and
at least one light source installed inside the housing, the light source being configured to allow light suitable to view the substrate.

8. The method according to claim 7, wherein the light source is a light-emitting diode (LED) and a battery which serves as a power source for the light source.

9. The method according to claim 1, wherein the magnifying lens has a magnification strength of from about 2× to about 100×, preferably from about 5× to about 50×, and more preferably from about 5× to about 10×.

10. The method according to claim 1, wherein the viewing plate is positioned at a distance from about 1.0 cm to about 1.8 cm, preferably from about 1.2 cm to about 1.6 cm, and more preferably from about 1.5 cm, from the magnifying lens.

11. A portable magnifying device for providing to a consumer a portable viewing of the effectiveness of a treatment of a product on a substrate comprising a housing and a viewing plate mounted inside the housing, the housing comprises at least one magnifying lens, preferably comprises three magnifying lenses, disposed within a top surface of the housing, and the viewing plate is configured to support the substrate such that it can be viewed through the magnifying lens by the consumer.

12. The portable magnifying device of claim 11, further comprising:
a cover configured to block off exterior light from entering the housing; and
at least one light source installed inside the housing, the light source being configured to allow light suitable to view the substrate.

13. The portable magnifying device of claim 12, wherein the light source is a light-emitting diode (LED) and a battery serves as a power source for the light source.

14. The portable magnifying device of claim 11, wherein the magnifying lens has a magnification strength of from about 2× to about 100×, preferably from about 5× to about 50×, and more preferably from about 5× to about 10×.

15. The portable magnifying device of claim 11, wherein the viewing plate is positioned at a distance of from about 1.0 cm to about 1.8 cm, preferably from about 1.2 cm to about 1.6 cm, and more preferably from about 1.5 cm, from the magnifying lens.

16. A kit of parts (whether assembled or not) for providing to a consumer portable viewing of the effectiveness of a treatment of a product on a substrate, which comprises the portable magnifying device as claimed in any of claims 11 to 15.
